(19) United States
(12) Patent Application Publication
(10) Pub. No.: US 2024/0017592 A1
(43) Pub. Date: Jan. 18, 2024

(54) Method and System For Monitoring the Environment of a Cabin and Regulating The Pressurisation of Same

(71) Applicant: Work Air Technologies Pty, Ltd, Wangara (AU)

(72) Inventor: Gregory Brian Knowles, Wangara (AU)

(21) Appl. No.: 18/255,722

(22) PCT Filed: Dec. 3, 2021
(86) PCT No.: PCT/AU2021/051450

§ 371 Date: Jun. 2, 2023

(30) Foreign Application Priority Data
Dec. 4, 2020 (AU) 2020904509

(51) Int. Cl. B60H 1/00; B60H 3/06; B60H 1/24

(52) U.S. Cl. CPC B60H 1/008; B60H 3/06; B60H 1/24

(57) ABSTRACT

A system (10) for monitoring the environment of a cabin (1) comprising an air pressurisation system (12), filtration means (22), at least one air pressure sensor (14), a vent (16), and control means (18). The air pressurisation system (12) continuously supplies pressurised air to the filtration means (22) at a constant flowrate, the pressurised air ultimately being delivered to the cabin (1). The control means (18) determines the air pressure of the cabin (1) by way of the at least one air pressure sensor (14) and compares the current air pressure level against a desired air pressure level to obtain a first comparative value. The control means (18) thereafter operable to control the state of the vent (16) in response to at least the first comparative value. A method of monitoring and regulating the environment of a cabin (1) is also disclosed.

### FIELD OF THE INVENTION

The invention relates to a method and system for monitoring the environment of a cabin. A further variation of the invention also incorporates regulating the pressurisation of same. The invention is particularly suited to environmental monitoring and regulating the pressurised cabin of a vehicle.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Pressurisation of a vehicle cabin is commonly used as a means of preventing ingress of contaminants. In an ideal environment, regulating the desired level of pressurisation of the vehicle cabin is easily done through the steady supply of air at the desired pressure. However, in practice, a vehicle cabin has at least some unknown level of leakage and this can vary according to time and circumstance.

A further complicating factor is that external forces, such as wind levels, can also impact on cabin pressurisation levels. Thus, in order to compensate for both internal factors (such as the known and unknown leakage sources) and these external factors, cabin pressure must be constantly measured to facilitate regulation.

Prior art systems seek to regulate cabin pressure by regular measurement of cabin pressure through a plurality of sensors. When a sensor measurement falls outside a threshold range, prior art systems operate to correspondingly adjust the speed of the air pressurisation fan and thereby speed up or slow down pressurised air supplied to the cabin.

By speeding up air supplied by the air pressurisation fan, low pressurisation of the cabin can be compensated for. Similarly, by slowing down air supplied by the air pressurisation fan, over pressurisation of the cabin can be compensated for.

The problem with this approach resides in situations where the cabin has been over pressurised. Slowing down air supplied by the air pressurisation system causes problems with cyclonic downstream filters. Specifically, the reduced air speed does not facilitate centrifugal separation of larger contaminants for diversion to particle outtakes resulting in such contaminants reaching pressurisation filtration systems. Over time, this will render the pressurisation filtration systems prone to blockages.

A consequential problem of this approach is that if the cabin is over-pressurised and the pressurisation filtration systems are blocked (even partly) there may not be sufficient oxygen exchange occurring in the cabin. Oxygen exchange is important in preventing a build-up of CO₂ levels in the cabin which can have significant health consequences for any person located in the cabin.

It is therefore an object of the present invention to provide an alternate method and system for monitoring and regulating a pressurised cabin. It is an optional object of the present invention to provide a method and system for monitoring and regulating a pressurised cabin that overcomes, or at least ameliorates in part, the aforementioned problem of prior art systems.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

Similarly, in the context of the present invention, while the invention seeks to monitor and regulate the pressure of a cabin, it is to be appreciated by the person skilled in the art that this may require the system to interact with components such as environmental monitoring systems that are located remote of the cabin as well as components that are located within or proximate the cabin itself.

In accordance with a first aspect of the present invention there is a system for monitoring the environment of a cabin comprising:
an air pressurisation system;
filtration means;
at least one air pressure sensor;
a vent; and
control means
   where, the air pressurisation system continuously supplies pressurised air to the filtration means at a constant flowrate, such pressurised air ultimately being delivered to the cabin and where, the control means is operable to determine the air pressure of the cabin by way of the at least one air pressure sensor and compare the current air pressure level against a desired air pressure level to obtain a first comparative value, the control means thereafter operable to control the state of the vent in response to at least the first comparative value.

The filtration means may incorporate a cyclonic separator and/or a HEPA filter.

The vent may be an atmospheric vent. In other configurations, the vent may direct air back to the filtration means (or another filtration means). Ideally, the vent has more than a binary, on-off state.

The system may include additional sensors and at least one of the additional sensors operable to measure the level of a contaminant in the cabin and provide that measurement to the control means. The control means operable to automatically set the vent to the fully open state if the measured level of the contaminant in the cabin exceeds a threshold level. In one preferred variation, the contaminant is CO₂.

The control means may operate to automatically set the vent to the fully open state on any of the following events being detected by the control means: vehicle startup; vehicle shutdown.

The control means may apply a smoothing algorithm when controlling the state of the vent to prevent fluttering.

In a preferred arrangement that facilitates regulation of cabin air pressure, the system also includes at least one airflow sensor and where the control means is further operable to determine an incoming airflow rate of the pressurised air subsequent to filtration by the filtration means, the control means operable to control the state of the atmospheric vent in response to at least the first comparative value and the incoming airflow rate. A still preferred arrangement has the at least one airflow sensor including a vent airflow sensor, the vent airflow sensor positioned so as to measure the amount of air exiting the cabin by way of the vent, the control means operable to compare the incoming airflow rate with the amount of air exiting the cabin as determined by the vent airflow sensor to obtain a second comparative value, the control means thereafter operable to control the state of the vent in response to the first comparative value and the second comparative value.

The control means may diagnose potential problems with the system based on one or more of the following: the first comparative value; the incoming airflow rate.

The cabin may include at least one known closable leak source, and the system may include at least one sensor for detecting when the closable leak source is open, the control means operable to factor in the status of one or more closable leak sources in determining the state that the vent should be set at. The closable leak source may be a door to the cabin or a window in the cabin.

In accordance with a second aspect of the present invention there is a method of monitoring the environment of a cabin comprising the steps of:
continuously supplying pressurised air to a filtration means at a constant flowrate;
filtering the supplied pressurised air and delivering same to a cabin;
measuring the air pressure of air in the cabin;
comparing the current air pressure level against a desired air pressure level to obtain a first comparative value;
determining the state a vent in the cabin should be set to based on at least the first comparative value;
controlling the vent to move to the determined state.

In a variant of this method, the method includes the following steps of:
measuring the level of a contaminant in the cabin; and
automatically determining the state the vent should be set to too be a fully open state if the measured level of the contaminant in the cabin exceeds a threshold level.

The method may also comprise the step of determining the state the vent should be set to too be a fully open state on any of the following events being detected: vehicle startup; vehicle shutdown.

The method step of determining the state the vent should be set to may further include the substep of applying a smoothing algorithm to prevent the vent from fluttering.

In a preferred arrangement, the method also includes the steps of:
determining an incoming airflow rate of the pressurised air subsequent to filtration by the filtration means;
further determining the state the vent should be set to based on the incoming airflow rate.

The method may also include the steps of:
determining an outgoing airflow rate of air passing through the vent;
comparing the incoming airflow rate with the outgoing airflow rate to obtain a second comparative value; and
further determining the state the vent should be set to based on the second comparative value.

The method may also provide for diagnostic assessment based on one or more of the following: the first comparative value; the incoming airflow rate. In a still further arrangement, the method may include the steps of:
determining the state of a closable leak source; and
factoring the determined state of the closable leak source in determining the state the vent should be set to.

### BRIEF DESCRIPTION OF THE DRAWINGS

The invention will now be described, by way of example only, with reference to the accompanying drawings, in which:

FIG. 1 is a schematic representation of a system for monitoring the environment of a cabin according to a first embodiment of the invention.

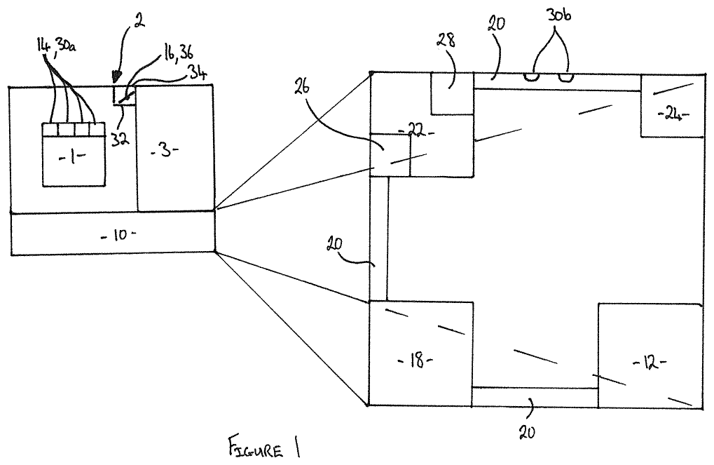

FIG. 2 is a schematic representation of a system for monitoring the environment of a cabin according to a second embodiment of the invention.

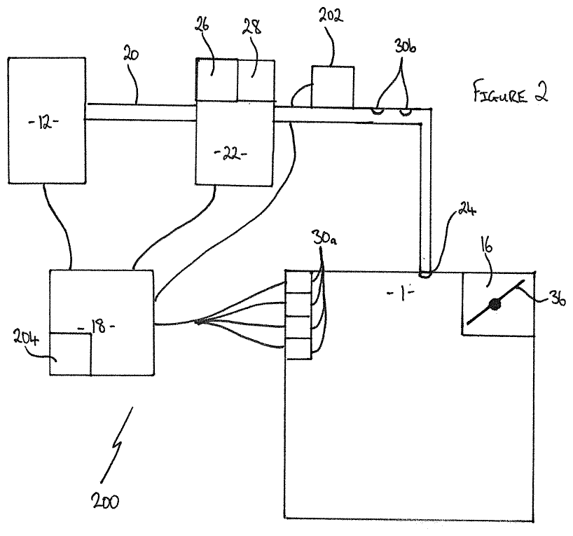

FIG. 3 is a schematic representation of a system for monitoring the environment of a cabin according to a third embodiment of the invention.

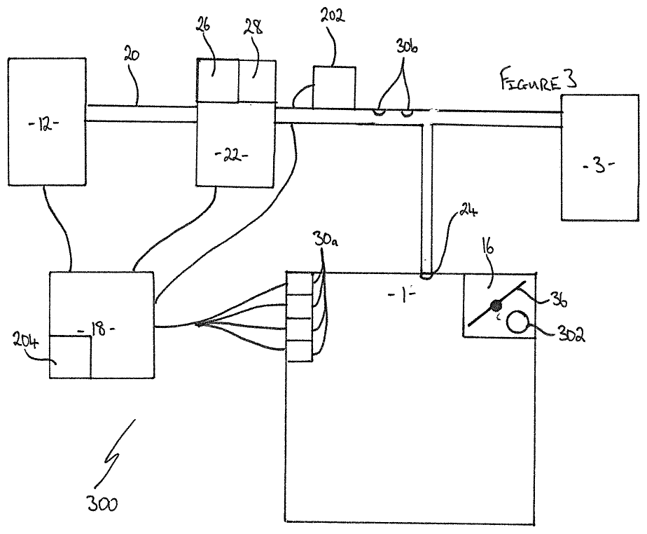

FIG. 4 is a flowchart of a method for monitoring the environment of a cabin according to the first embodiment of the invention.

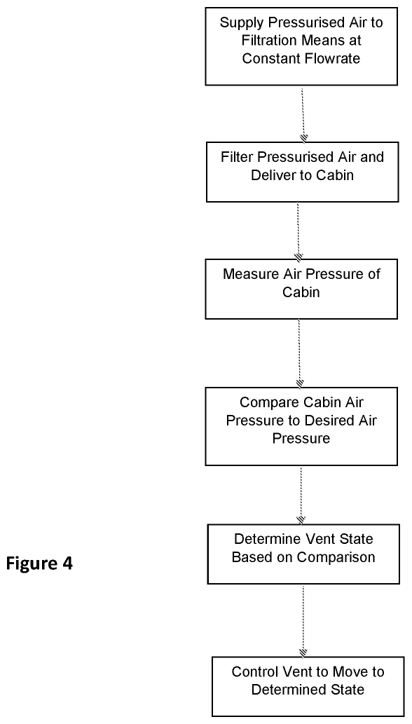

### PREFERRED EMBODIMENTS OF THE INVENTION

In accordance with a first embodiment of the invention there is a system 10 for monitoring a cabin 1 and regulating the pressurisation of same. In this embodiment the pressurised cabin 1 forms part of a vehicle 2.

The system 10 comprises an air pressurisation system 12, a set of sensors 14, an atmospheric vent 16 and control means 18. The control means 18 is in data and control communication with the air pressurisation system 12, each sensor 14 in the set of sensors 14 and the atmospheric vent 16.

The air pressurisation system 12 takes the form of an add-on to the original equipment manufacturer (“OEM”) supplied air conditioning system 3 for the cabin 1. As such, the air pressurisation system 12 utilises the same plurality of conduits 20 as the air conditioning system 3 uses to supply conditioned air to the cabin 1. This also means that the air conditioning system 3 and air pressurisation system 12 also utilise the same filtration system 22.

Each conduit 20 opens to the cabin 1 by way of a cabin vent 24.

In this embodiment, the filtration system 22 comprises a cyclonic separator 26 and a HEPA filter 28. The cyclonic separator 26 is located upstream of the HEPA filter 28.

The set of sensors 14 are grouped into two subsets 30a, 30b. The first subset 30a comprises sensors for monitoring air pressure that are located at positions within the cabin 1. The second subset 30b comprises sensors for monitoring air pressure that are located at positions along the conduits 20.

The atmospheric vent 16 is located at a desired position within the cabin 1. The atmospheric vent 16 has a cabin side 32 and an atmosphere side 34. The cabin side 32 opens onto the internal of the cabin 1. The atmospheric side 34 opens onto the atmosphere at large (i.e. the atmosphere outside of the cabin 1).

The atmospheric vent 16 incorporates a positioning valve 36. The positioning valve 36 controls whether the atmospheric vent 16 is in an open or a closed position as well as the extent to which the atmospheric vent 16 is in an open or closed position.

This embodiment of the invention will now be described in the context of its intended use.

The air pressurisation system 12 commences pressurisation of air to be supplied to the cabin 1. The pressurised air is then supplied to the cabin 1 by way of conduits 20 to the filtration system 22.

The pressurised air received by the filtration system 22 first passes through the cyclonic separator 26. In doing so at least some particulates located therein will be centrifugally separated from the air stream and directed towards an outtake 38. The remainder of the air stream is directed towards the HEPA filter 28 for secondary filtration before being dispersed into the cabin 1 by way of cabin vents 24.

It is important to note here that throughout the operation of the invention, the air pressurisation system 12 operates to continuously supply air having a constant pressure level and speed that allows the cyclonic separator 26 to work efficiently.

At short periodic intervals, the control means 18 sends an appropriate control signal to each sensor 14 in the set of sensors 14. As each sensor 14 receives the control signal, it operates to measure the air pressure at its location and return the measurement value back to the control means 18 along with a sensor identifier.

Once the control means 18 has received measurements back from each sensor 14, it initially analyses the measurements of the cabin sensors 14 (i.e. the sensors forming subset 30a). This analysis first involves comparing each measurement against a set of predetermined threshold values set for the cabin 1. If each measurement falls within the range bounded by these threshold values, no further action is taken.

If a measurement exceeds a threshold value, the control means 18 references the sensor identifier associated with the exceeding measurement to identify the sensor 14 that has produced the anomalous measurement. This process is repeated until all measurements that exceed a threshold value have been similarly processed and a set of sensors 14 which have produced anomalous measurements determined.

The control means 18 then processes the set of sensors 14 that have produced anomalous measurements so as to determine the cause of the anomalous results. To elaborate, if this set of sensors 14 includes all sensors 14 of subset 30a, and each report a measurement above the upper predetermined threshold value, then the control means 18 assesses the cause as overpressurisation of the cabin 1. Alternatively, if this set of sensors 14 includes all sensors 14 of subset 30a, and each report a measurement below the lower predetermined threshold value, then the control means 18 assesses the cause as underpressurisation of the cabin 1.

If the set of sensors 14 only includes a partial set of sensors 14 of subset 30a, or includes sensors 14 forming part of subset 30b, the control means 18 may assess the cause as potential sensor error or malfunction.

On the control means 18 assessing the cabin 1 as being overpressurised, the control means 18 sends an open signal to the positioning valve 36. In response to the open signal, the positioning valve 36 operates to open the atmospheric vent 16 and thereby allow pressurised air contained in the cabin 1 to vent to atmosphere.

Alternatively, on the control means 18 assessing the cabin 1 as being underpressurised, the control means 18 sends a close signal to the positioning valve 36. In response to the close signal, the positioning valve 36 operates to close the atmospheric vent 16 and thereby prevent pressurised air from venting from the cabin 1 to the atmosphere.

It is important to note that by utilising the atmospheric vent 16 as a known and controllable leak source, the invention ensures that remedial action undertaken by the control means 18 in response to recent air pressure measurement is not undermined by unknown leaks in the cabin 1. Furthermore, by continuously supplying pressurised air to the cabin 1 at a constant speed (and at a speed that facilitates centrifugal separation of particles by the cyclonic separator 26) the invention takes out of contention a variable that otherwise impacts pressurisation of the cabin 1.

In accordance with a second embodiment of the invention, where like numerals reference like parts, there is a system 200 for monitoring a cabin 1. The system 200 is identical to the system 10, except for the addition of an in-line airflow sensor 202.

In this embodiment, the in-line airflow sensor 202 is located within conduits 20 at a position between the air pressurisation system 12 and the cyclonic separator 26. The in-line airflow sensor 202 is in data and control communication with the control means 18.

The positioning valve 36 of this embodiment has a stepped operation. In this manner, during use, each step of the positioning valve 36 operates to adjust the angle of the atmospheric vent 16.

This embodiment will now be described in the context of its intended use.

The air pressurisation system 12 commences pressurisation of air to be supplied to the cabin 1. The pressurised air is then continuously supplied to the cabin 1 by way of conduits 20 to the filtration system 22.

The pressurised air received by the filtration system 22 first passes through the cyclonic separator 26. In doing so at least some particulates located therein will be centrifugally separated from the air stream and directed towards an outtake 38. The remainder of the air stream is directed towards the HEPA filter 28 for secondary filtration before being dispersed into the cabin 1 by way of cabin vents 24.

As with the first embodiment, the air pressurisation system 12 operates to continuously supply air having a constant pressure level and speed that allows the cyclonic separator 26 to work efficiently.

At short periodic intervals, the control means 18 sends an appropriate control signal to each sensor 14 in the set of sensors 14 as well as the in-line airflow sensor 202. As each sensor 14 receives the control signal, it operates to measure the air pressure at its location and return the measurement value back to the control means 18 along with a sensor identifier. Similarly, when the in-line airflow sensor 202 receives the control signal, it operates to measure the air pressure in the conduit 20 where it is placed and return the measurement value back to the control means 18.

Once the control means 18 has received measurements back from each sensor 14 and the in-line airflow sensor 202, it initially analyses the measurements of the cabin sensors 14 (i.e. the sensors forming subset 30a). This analysis first involves comparing each measurement against a set of predetermined threshold values set for the cabin 1. If each measurement falls within the range bounded by these threshold values, no further action is taken.

If a measurement exceeds a threshold value, the control means 18 references the sensor identifier associated with the exceeding measurement to identify the sensor 14 that has produced the anomalous measurement. This process is repeated until all measurements that exceed a threshold value have been similarly processed and a set of sensors 14 which have produced anomalous measurements determined.

The control means 18 then processes the set of sensors 14 that have produced anomalous measurements so as to determine the cause of the anomalous results. To elaborate, if this set of sensors 14 includes all sensors 14 of subset 30a, and each report a measurement above the upper predetermined threshold value, then the control means 18 assesses the cause as overpressurisation of the cabin 1. Alternatively, if this set of sensors 14 includes all sensors 14 of subset 30a, and each report a measurement below the lower predetermined threshold value, then the control means 18 assesses the cause as underpressurisation of the cabin 1.

If the set of sensors 14 only includes a partial set of sensors 14 of subset or includes sensors 14 forming part of subset 30b, the control means 18 may assess the cause as potential sensor error or malfunction.

On the control means 18 assessing the cabin 1 as being overpressurised, the control means 18 operates to determine the level of overpressurisation. To elaborate, the control means 18 determines the mean pressure level as measured by each of the sensors 14 in subset 30a and compares this value against a predetermined pressure level. The calculated difference then represents the level of overpressurisation.

The control means 18 then references the calculated difference of overpressurisation against a positioning table 204. On determining the record of the positioning table 204 matching the calculated difference of overpressurisation, the control means 18 obtains the associated stepped value.

Having obtained the desired stepped value, the control means 18 sends a command signal to the positioning valve 36 to open to that stepped value. In response to the signal, the positioning valve 36 moves to the position associated with that stepped value, which in turn adjusts the open angle of the atmospheric vent 16 to allow pressurised air to vent from the cabin 1 to the atmosphere at the desired rate.

Additionally, having determined the level of overpressurisation, the control means 18 also undertakes a preliminary diagnosis of the potential cause of the overpressurisation. To do this, the control means 18 makes a comparison of the air flow measurement taken by the in-line airflow sensor 202 against a further predetermined value. The further predetermined value represents the airflow rate measured by the in-line airflow sensor 202 during normal operation.

If the comparison between current air flow measurement and predetermined value shows little difference in air flow or a marked reduction in air flow, the control means 18 assesses the reason for the overpressurisation as the likely failure of the atmospheric vent 16 or that the atmospheric vent 16 is fully closed. However, if the difference shows there to be an increase in air flow compared to the predetermined value, then the control means 18 assesses the reason for the overpressurisation as being either a failure of the filtration system 22, or that the filtration system 22 has not been installed (or installed properly).

On the control means 18 assessing the cabin 1 as being underpressurised, the control means 18 operates to determine the level of underpressurisation. To elaborate, the control means 18 determines the mean pressure level as measured by each of the sensors 14 in subset 30a and compares this value against a yet further predetermined pressure level. The calculated difference then represents the level of underpressurisation. The predetermined pressure level is the intended minimum operational pressure level of the air pressurisation system 2.

The control means 18 then references the calculated difference of underpressurisation against the positioning table 204. On determining the record of the positioning table 204 matching the calculated difference of underpressurisation, the control means 18 obtains the associated stepped value.

Having obtained the desired stepped value, the control means 18 sends a command signal to the positioning valve 36 to close to that stepped value. In response to the signal, the positioning valve 36 moved to the position associated with that stepped value, which in turn adjusts the open angle of the atmospheric vent 16 to reduce the rate of pressurised air venting from the cabin 1 to the atmosphere.

Again, having determined the level of underpressurisation, the control means 18 also undertakes a preliminary diagnosis of the potential cause of the underpressurisation. To do this, the control means 18 makes a comparison of the air flow measurement taken by the in-line airflow sensor 202 against the predetermined value (i.e. the value representing the airflow rate measured by the in-line airflow sensor 202 during normal operation).

If the comparison between current air flow measurement and predetermined value shows little difference in air flow or a marked increase in air flow, the control means 18 assesses the reason for the underpressurisation as a likely cabin leak. However, if the difference shows there to be an increase in air flow compared to the predetermined value, then the control means 18 assesses the reason for the underpressurisation as being either a failure of the air pressurisation system 12 or that the air pressurisation system 12 is underperforming.

It is to be appreciated by the person skilled in the art that the stepped approach to the angled positioning of the atmospheric vent 16 may, in practice, result in positioning valve 36 reciprocating between two stepped values in quick succession. As this is undesirable, the invention may incorporate a smoothing algorithm that results in the positioning valve 36 continuing to reciprocate between the two stepped values, but over a longer timeframe.

In accordance with a third embodiment of the invention, where like numerals reference like parts, there is a system 300 for monitoring a cabin 1. The system 300 is identical to the system 200, but with the additional of a vent airflow sensor 302.

The vent airflow sensor 302 is attached to the atmospheric vent 16 such that the amount of air that escapes from the cabin 1 by way of the atmospheric vent 16 can be properly measured. Such placement must facilitate this required measurement regardless of the stepped position of the positioning valve 36.

The vent airflow sensor 302 is in data communication with the control means 18. In this embodiment, the vent airflow sensor 302 and in-line airflow sensor 202 take measurements at the same periodic interval and are synchronised in their taking of measurements.

This embodiment of the invention will now be described in the context of its intended use.

The air pressurisation system 12 operates to pressurise air to a desired level and continuously convey the pressurised air at a uniform rate towards the filtration system 22. This uniform rate of flow of air provided by the pressurisation system 12 never changes so as to avoid the problem of potentially clogging the filtration system 22 as already described.

The air then passes through the filtration system 22 in the manner as described in the first embodiment, at which time the in-line airflow sensor 202 measures the flow of air through the conduit 20. This measurement is then communicated to the control means 18 as an incoming airflow measurement.

Due to their synchronisation, at the same time as the in-line airflow sensor 202 measures air flowing through the conduit 20, the vent airflow sensor 302 measures the flow of air exiting the cabin 1 by way of the atmospheric vent 16. This measurement is then communicated to the control means 18 as an outgoing airflow measurement.

On receipt of the incoming airflow measurement and the outgoing airflow measurement, the control means operates to compare these values against each other and against the uniform operational flowrate of the air pressurisation system 12.

As a first check, the control means 18 compares the incoming airflow measurement against the uniform operational flowrate of the air pressurisation system 12 to assess the performance of the filtration system 22. Specifically, if the incoming airflow measurement is significantly less than the uniform operational flowrate, this is indicative of issues with the filtration system 22 (i.e. it might be blocked, damaged or a filtration element may be missing).

The second check is to determine the difference between the incoming airflow measurement and the outgoing airflow measurement to arrive at a differential airflow value. As an initial measurement, this provides an indication of the current level of unknown cabin leakage. However, this level will vary over time according to environmental considerations, such as temperature.

The final check to be made is between the current air pressure level of the cabin 1, as determined by the first subset 30a of sensors 14, against the desired level of air pressure for the cabin 1 as known to the control means 18. If this check shows these levels to be equal (or within a set tolerance level) no further action is taken by the control means 18.

However, if this check shows the current air pressure level of the cabin 1 to be greater than the desired level of air pressure for the cabin 1, the control means 18 further compares the differential air pressure levels against the differential airflow value to determine a desired stepped value for the positioning valve 36.

Having obtained the desired stepped value, the control means 18 sends a command signal to the positioning valve 36 to open to that stepped value. In response to the signal, the positioning valve 36 moves to the position associated with that stepped value, which in turn adjusts the open angle of the atmospheric vent 16 to allow a higher level of pressurised air to vent from the cabin 1. To put it another way, the positioning valve 36 moves the atmospheric vent 16 more towards a fully open position.

Alternatively, if this check shows the current air pressure level of the cabin 1 to be lower than the desired level of air pressure for the cabin 1, the control means 18 further compares the differential air pressure levels against the differential airflow value to determine a desired stepped value for the positioning valve 36.

Having obtained the desired stepped value, the control means 18 sends a command signal to the positioning valve 36 to open to that stepped value. In response to the signal, the positioning valve 36 moves to the position associated with that stepped value, which in turn adjusts the open angle of the atmospheric vent 16 to allow a lower level of pressurised air to vent from the cabin 1. To put it another way, the positioning valve 36 moves the atmospheric vent 16 more towards a fully closed position.

The advantage of this embodiment is that the system 300 operates to regulate cabin pressure by utilising variable positions of the atmospheric vent 16 to compensate for unknown cabin leakage and environmental factors that influence air pressure.

Each of the above embodiments has been described within the context of a single processing loop. However, it is to be understood that the invention described iterates this processing loop continuously during operation.

It should be further appreciated by the person skilled in the art that the above invention is not limited to the embodiments described. In particular, the following modifications and improvements may be made without departing from the scope of the present invention:
In a variation of the second embodiment of the invention described above, additional in-line airflow sensors 202 may be installed in the conduits 20. For instance, by installing an in-line airflow sensor 202 shortly after the filtration system 22, in the event of underpressurisation, the control system 18 can compare measurements from both in-line airflow sensors 202 against the predetermined pressure level to determine whether the underpressurisation is the result of issues with the air pressurisation system 12 or issues with the filtration system 22.
While the above embodiments have been described in the context of a single atmospheric vent 16, a plurality of atmospheric vents 16 may be employed. This is particularly useful in situations where the cabin 1 is compartmentalised.
While it is preferable that the atmospheric vent 16 can adjust position to control the flow rate of air passing therethrough, the atmospheric vent 16 can be binary in nature (i.e. either open or closed). In such a configuration it is desirable that multiple binary atmospheric vents 16 be employed such that the flow rate of air leaving the cabin 1 by way of the binary atmospheric vents 16 can be at least partially controlled by the number of binary atmospheric vents 16 set to open.
The atmospheric vent(s) 16 may be configured to open automatically on certain events. For instance, the atmospheric vents 16 may automatically open on startup of the vehicle as a means of obtaining rapid cooldown of the cabin 1. Similarly, the atmospheric vents 16 may automatically open on shutdown of the vehicle as a means of facilitating easier opening of the door to the cabin 1.
Additional sensors (not shown) may be incorporated into the above system to detect the presence of contaminants within the cabin 1. For instance, additional sensors may be incorporated into the system to detect the presence and amount of dust, nanoparticles, diesel particulates, SO₂ and methane in the cabin 1.
In a preferred arrangement, the embodiments described above further incorporate at least one CO₂ sensor. The control means 18 operates to compare measurement values taken by these CO₂ sensors versus a threshold measurement value. If the measurements exceed this threshold measurement value, then the control means 18 sends appropriate signals to the positioning valve 36 to move the atmospheric vent 16 to a fully open position so as to allow for the CO₂ to be purged from the cabin.
The control means 18 may also use the measurement values taken by a CO₂ sensor in determining the angled position that the atmospheric vent 16 should be moved too.
Means of determining the angled position that the atmospheric vent 16 should be moved to other than those described above may be employed without departing from the scope of the present invention.
Yet additional sensors may be installed on known leak sources within the cabin 1, such as doors and windows. These additional sensors can be used to determine the state of the known leak source and thus assist in determining whether the state of the known leak source impacts on the reason for overpressurisation or underpressurisation of the cabin 1.
The control means 18 may incorporate external input mechanisms to allow a remote source, or an operator, to set parameters such as the desired pressure level of the cabin 1.
In a similar manner, the control means 18 may be in data and control communication with a communications system to allow telemetry data generated by the system 10, 200 to be communicated to a remote site. One such communication system that may be employed is that the subject of the Applicant's simultaneously filed Australian standard patent application titled “Field Telemetry System for an Environmental Control System”
In alternative configurations of the invention, the conduits 20 may be dedicated conduits 20 for the air pressurisation system 12 rather than being shared conduits with the OEM air conditioning system 3.
While the invention has been described in the context of pressurised air being vented to the atmosphere by way of atmospheric valve(s) 16, in other configurations within the scope of this invention, air bled from the cabin by way of atmospheric valve(s) 16 may be directed back to the filtration system 22.
Where the configuration allows it, the in-line airflow sensor 202 may form part of the filtration system 22, being located after the cyclonic separator 26 but before the HEPA filter 28.
The HEPA filter 28 may be replaced with other types of filters including EPA, UPA, MERV and carbon, as examples, or a combination thereof.
It is desirable that the sensors, especially the contaminant sensors, be located within an area defined as the area where an operator between a predetermined minimum height and a predetermined maximum height would draw and expel breath when properly seated in an operator's seat located within the cabin (i.e. a “breathing zone”). However, when the invention is used in an autonomous vehicle, it is desirable that such sensors be located proximate an air intake port or air exhaust port of the autonomous control system used to control the vehicle.
Any of the aforementioned embodiments may further incorporate a user interface through which data and warning may be presented to an operator. The user interface may be purely visual (such as by a screen), or purely audible (with information and warnings being given by way of a computerised voice or warning sounds) or a combination of the audible and visual.

It should be further appreciated by the person skilled in the art that the invention is not limited to the embodiments described above. Additions or modifications described, where not mutually exclusive, can be combined to form yet further embodiments that are considered to be within the scope of the present invention.

1.-34. (canceled)

35. A system for monitoring the environment of a cabin comprising:
an air pressurization system;
filtration means;
at least one air pressure sensor;
an outflow vent in the cabin; and
control means;
wherein, during operation, the air pressurization system is configured to continuously supply pressurized air having a constant pressure level and speed direct to the filtration means, such pressurized air ultimately being delivered to the cabin and wherein, the control means is configured to determine an air pressure of the cabin by way of the at least one air pressure sensor and compare a current air pressure level against a desired air pressure level to obtain a first comparative value, the control means further configured to control a state of the outflow vent in response to at least the first comparative value.

36. The system according to claim 35, wherein the filtration means includes a cyclonic separator.

37. The system according to claim 36, wherein the filtration means further includes at least one of the following: a HEPA filter; an EPA filter; a UPA filter; a MERV filter; a carbon filter.

38. The system according to claim 36, wherein the cyclonic separator is operably coupled upstream of a remainder of the filtration system.

39. The system according to claim 35, wherein at least a first of the at least one air pressure sensor is located within the cabin.

40. The system according to claim 35, wherein the outflow vent is an atmospheric vent.

41. The system according to claim 35, wherein the outflow vent is configured such that air escaping from the cabin by way of the outflow vent is redirected to the filtration means.

42. The system according to claim 35, further comprising additional sensors, at least one of the additional sensors configured to measure a level of a contaminant in the cabin and provide the measured level to the control means, and wherein the control means is configured to automatically set the outflow vent to a fully open state if the measured level of the contaminant in the cabin exceeds a threshold level.

43. The system according to claim 42, wherein the contaminant is at least one of the following: carbon dioxide; dust; nanoparticles; diesel particulates; methane.

44. The system according to claim 42, wherein the control means is configured to automatically set the outflow vent to the fully open state on any of the following events being detected by the control means: vehicle startup; vehicle shutdown.

45. The system according to claim 42, wherein the control means further applies a smoothing algorithm when controlling the state of the outflow vent to prevent fluttering.

46. A method of monitoring the environment of a cabin comprising the steps of:
continuously supplying pressurized air direct to a filtration means during operation at a constant pressure level and speed;
filtering the supplied pressurized air to generate filtered pressurized air, and delivering the filtered pressurized to the cabin;
measuring an air pressure in the cabin;
comparing a current air pressure level against a desired air pressure level to obtain a first comparative value;
determining a state an outflow vent in the cabin should be set to based on at least the first comparative value;
controlling the outflow vent to move to the determined state.

47. The method according to claim 46, further comprising the step of redirecting air escaping the cabin to the filtration means via the outflow vent.

48. The method according to claim 46, further comprising the steps of:
measuring a level of a contaminant in the cabin; and
automatically determining the state the outflow vent should be set to to be a fully open state if the measured level of the contaminant in the cabin exceeds a threshold level.

49. The method according to claim 48, wherein the contaminant is at least one of the following: CO₂; dust; nanoparticles; diesel particulates; methane.

50. The method according to claim 46, further comprising a step of determining the state the outflow vent should be set to to be a fully open state on any of the following events being detected: vehicle startup; vehicle shutdown.

51. The method according to claim 46, wherein the step of determining the state the outflow vent should be set to includes the substep of applying a smoothing algorithm to prevent the vent from fluttering.

52. The method according to claim 46, further comprising the steps of:
determining an incoming airflow rate of the filtered pressurized air;
factoring the incoming airflow rate in determining the state the outflow vent should be set to.

53. The method according to claim 46, further comprising the steps of:
determining an outgoing airflow rate of air passing through the outflow vent;
comparing an incoming airflow rate with the outgoing airflow rate to obtain a second comparative value; and
factoring the second comparative value in determining the state the outflow vent should be set to.

54. The method according to claim 46, further comprising the steps of:
determining a state of a closable leak source; and
factoring the determined state of the closable leak source in determining the state the outflow vent should be set to.
